(19) United States
(12) Patent Application Publication
(10) Pub. No.: US 2023/0163897 A1
(43) Pub. Date: May 25, 2023

(54) TYPE 3 HYBRID AUTOMATIC REPEAT REQUEST CODEBOOK FEEDBACK TRIGGERING

(71) Applicant: QUALCOMM Incorporated, San Diego, CA (US)

(72) Inventors: Konstantinos DIMOU, New York, NY (US); Yan ZHOU, San Diego, CA (US); Jing SUN, San Diego, CA (US); Tao LUO, San Diego, CA (US)

(21) Appl. No.: 18/057,181

(22) Filed: Nov. 18, 2022

Related U.S. Application Data
(60) Provisional application No. 63/264,563, filed on Nov. 24, 2021.

(51) Int. Cl. H04L 1/18; H04L 5/00

(52) U.S. Cl. CPC H04L 1/1861; H04L 5/001; H04L 1/1854

(57) ABSTRACT

Various aspects of the present disclosure generally relate to wireless communication. In some aspects, a user equipment (UE) may receive a downlink communication that includes a first field indicating that Type 3 hybrid automatic repeat request (HARQ) is triggered. The downlink communication includes one or more second fields that are repurposed to indicate one or more Type 3 HARQ codebooks configured for the UE. The UE may transmit HARQ feedback for the one or more Type 3 HARQ codebooks. Numerous other aspects are provided.

### CROSS-REFERENCE TO RELATED APPLICATION

This Patent Application claims priority to U.S. Provisional Patent Application No. 63/264,563, filed on Nov. 24, 2021, entitled “TYPE 3 HYBRID AUTOMATIC REPEAT REQUEST CODEBOOK FEEDBACK TRIGGERING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for Type 3 hybrid automatic repeat request (HARD) codebook feedback triggering.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a downlink communication that includes a first field indicating that Type 3 hybrid automatic repeat request (HARQ) is triggered, and one or more second fields that are repurposed to indicate one or more Type 3 HARQ codebooks configured for the UE. The method may include transmitting HARQ feedback for the one or more Type 3 HARQ codebooks.

Some aspects described herein relate to a method of wireless communication performed by a base station. The method may include transmitting a downlink communication that includes a first field indicating that Type 3 HARQ is triggered, and one or more second fields that are repurposed to indicate one or more Type 3 HARQ codebooks configured for a UE. The method may include receiving, from the UE, HARQ feedback for the one or more Type 3 HARQ codebooks.

Some aspects described herein relate to a UE for wireless communication. The user equipment may include a memory and one or more processors coupled to the memory. The one or more processors may be configured to receive a downlink communication that includes a first field indicating that Type 3 HARQ is triggered, and one or more second fields that are repurposed to indicate one or more Type 3 HARQ codebooks configured for the UE. The one or more processors may be configured to transmit HARQ feedback for the one or more Type 3 HARQ codebooks.

Some aspects described herein relate to a base station for wireless communication. The base station may include a memory and one or more processors coupled to the memory. The one or more processors may be configured to transmit a downlink communication that includes a first field indicating that Type 3 HARQ is triggered, and one or more second fields that are repurposed to indicate one or more Type 3 HARQ codebooks configured for a UE. The one or more processors may be configured to receive, from the UE, HARQ feedback for the one or more Type 3 HARQ codebooks.

Some aspects described herein relate to a non-transitory computer-readable medium that stores a set of instructions for wireless communication by a UE. The set of instructions, when executed by one or more processors of the UE, may cause the UE to receive a downlink communication that includes a first field indicating that Type 3 HARQ is triggered, and one or more second fields that are repurposed to indicate one or more Type 3 HARQ codebooks configured for the UE. The set of instructions, when executed by one or more processors of the UE, may cause the UE to transmit HARQ feedback for the one or more Type 3 HARQ codebooks.

Some aspects described herein relate to a non-transitory computer-readable medium that stores a set of instructions for wireless communication by a base station. The set of instructions, when executed by one or more processors of the base station, may cause the base station to transmit a downlink communication that includes a first field indicating that Type 3 HARQ is triggered, and one or more second fields that are repurposed to indicate one or more Type 3 HARQ codebooks configured for a UE. The set of instructions, when executed by one or more processors of the base station, may cause the base station to receive, from the UE, HARQ feedback for the one or more Type 3 HARQ codebooks.

Some aspects described herein relate to an apparatus for wireless communication. The apparatus may include means for receiving a downlink communication that includes, a first field indicating that Type 3 HARQ is triggered, and one or more second fields that are repurposed to indicate one or more Type 3 HARQ codebooks configured for the UE. The apparatus may include means for transmitting HARQ feedback for the one or more Type 3 HARQ codebooks.

Some aspects described herein relate to an apparatus for wireless communication. The apparatus may include means for transmitting a downlink communication that includes, a first field indicating that Type 3 HARQ is triggered, and one or more second fields that are repurposed to indicate one or more Type 3 HARQ codebooks configured for a UE. The apparatus may include means for receiving, from the UE, HARQ feedback for the one or more Type 3 HARQ codebooks.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3 and 4 are diagrams illustrating examples of Type 3 hybrid automatic repeat request (HARQ) codebook feedback triggering, in accordance with the present disclosure.

FIGS. 5 and 6 are diagrams illustrating example processes associated with Type 3 HARQ codebook feedback triggering, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

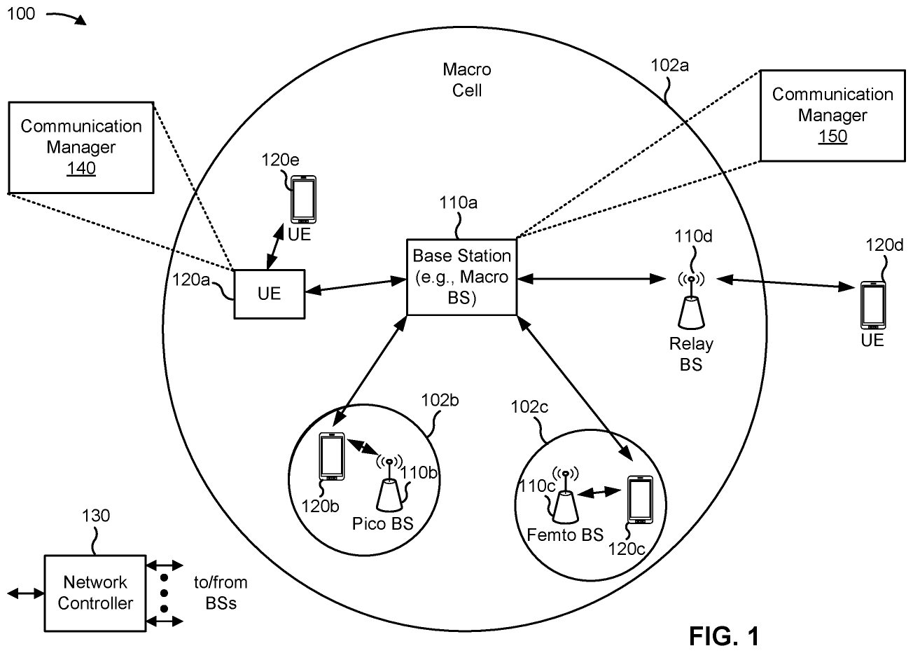

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) MC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a downlink communication that includes a first field indicating that Type 3 HARQ is triggered, and one or more second fields that are repurposed to indicate one or more Type 3 HARQ codebooks configured for the UE 120; and transmit HARQ feedback for the one or more Type 3 HARQ codebooks. Additionally, or alternatively, the communication manager 140 may perform one or more other operations described herein.

In some aspects, the base station 110 may include a communication manager 150. As described in more detail elsewhere herein, the communication manager 150 may transmit a downlink communication that includes a first field indicating that Type 3 HARQ is triggered, and one or more second fields that are repurposed to indicate one or more Type 3 HARQ codebooks configured for a UE 120; and receive, from the UE 120, HARQ feedback for the one or more Type 3 HARQ codebooks. Additionally, or alternatively, the communication manager 150 may perform one or more other operations described herein.

As indicated above, FIG. 1 is provided as an example. Other examples may differ from what is described with regard to FIG. 1.

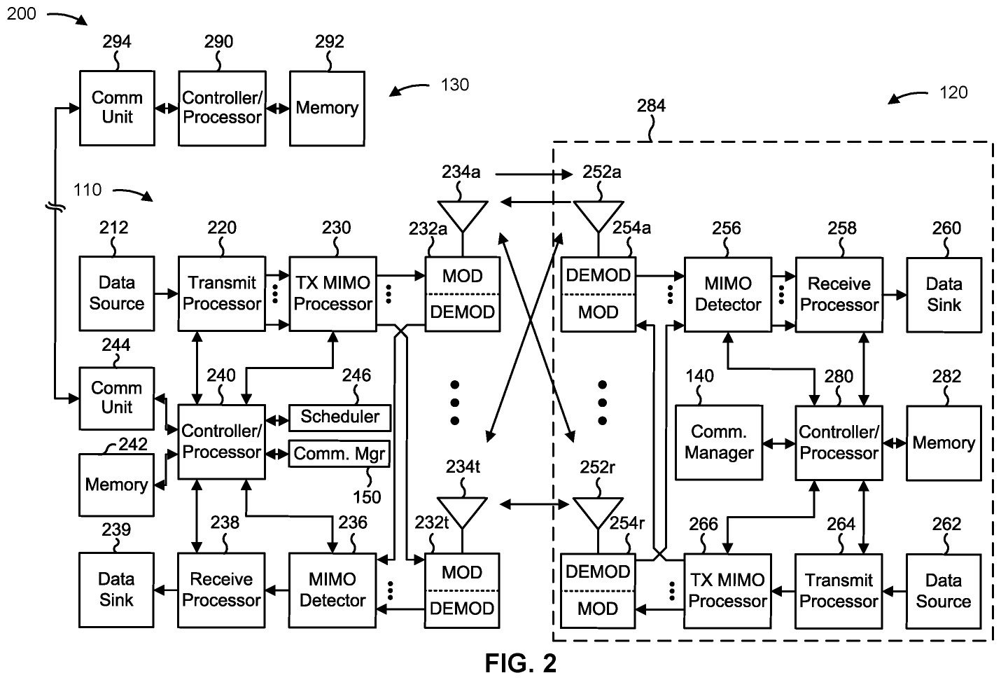

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T>1). The UE 120 may be equipped with a set of antennas 252a through 252r, such as R antennas (R>1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

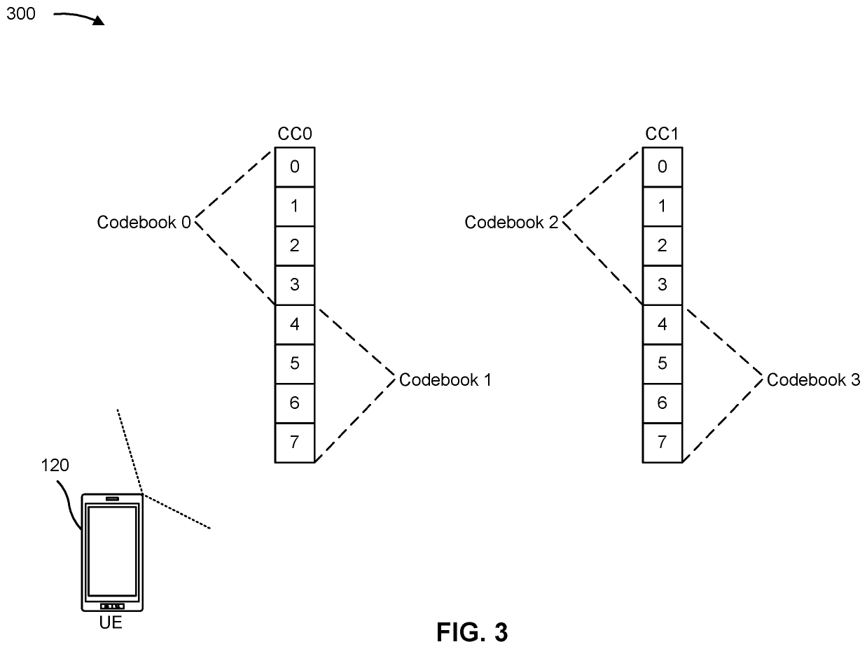

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

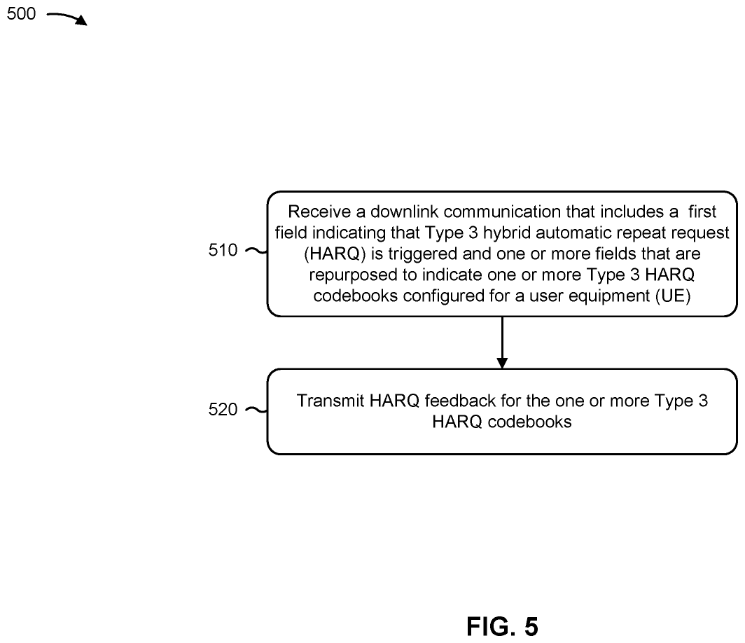

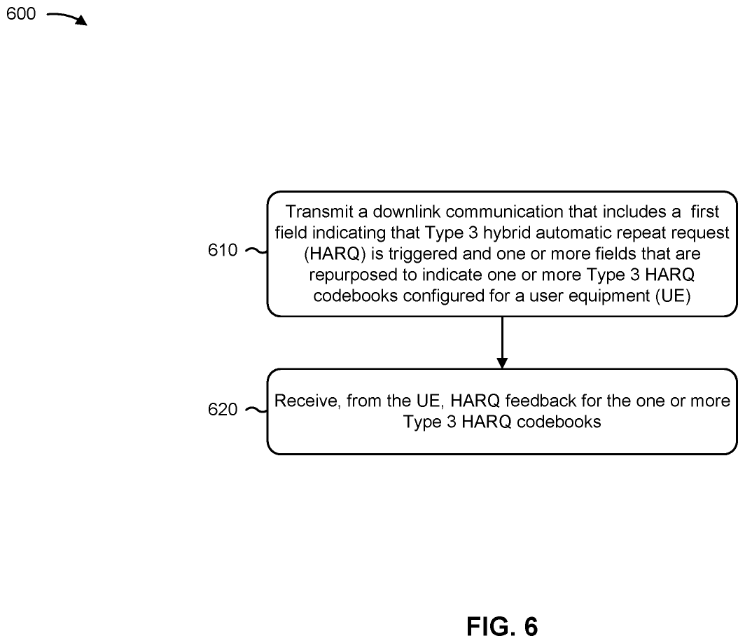

The controller/processor 240 of the base station 110, the controller/processor 280 of the UE 120, and/or any other component(s) of FIG. 2 may perform one or more techniques associated with Type 3 HARQ codebook triggering, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE 120 includes means for receiving a downlink communication that includes a first field indicating that Type 3 HARQ is triggered, and one or more second fields that are repurposed to indicate one or more Type 3 HARQ codebooks configured for the UE 120; and/or means for transmitting HARQ feedback for the one or more Type 3 HARQ codebooks. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting a downlink communication that includes: a first field indicating that Type 3 HARQ is triggered, and one or more second fields that are repurposed to indicate one or more Type 3 HARQ codebooks configured for a UE 120; and/or means for receiving, from the UE 120, HARQ feedback for the one or more Type 3 HARQ codebooks. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of Type 3 HARQ codebook feedback triggering, in accordance with the present disclosure. Type 3 HARQ codebook is a type of HARQ feedback implementation for acknowledgement and retransmission of communications in a wireless network. Type 1 HARQ feedback (or semi-static HARQ feedback), for example, includes a HARQ feedback implementation in which a wireless communication device (e.g., a UE 120 or a base station 110) transmits HARQ feedback for all communications received during a configured time duration (e.g., 10 slots or another time duration). Type 2 HARQ feedback includes a HARQ feedback implementation in which a wireless communication device transmits HARQ feedback on a per-packet basis, where the wireless communication device increments a counter for each HARQ feedback transmission.

Type 3 HARQ codebook feedback is a codebook-based implementation in which HARQ feedback is triggered based at least in part on component carriers configured for a wireless communication device. Type 3 HARQ codebook feedback is codebook based. The codebook(s) for Type 3 HARQ codebook feedback are HARQ process based in that the codebook(s) are ordered according to HARQ process identifiers and serving cells.

Type 3 HARQ codebook feedback may be provided based at least in part on an event, such as a semi-persistent scheduling (SPS) HARQ collision with a downlink transmission, a low-power HARQ being dropped internally at a base station due to intra-UE multiplexing, a HARQ feedback that is transmitted via a physical uplink shared channel (PUSCH) being cancelled, or a HARQ feedback not being decoded at a base station, among other examples.

Moreover, Type 3 HARQ codebook feedback may be implemented in communication scenarios in which access to wireless communication resources is not always guaranteed. For example, Type 3 HARQ codebook feedback may be implemented in unlicensed spectrum in which a UE (e.g., a UE 120) competes with multiple types of wireless communication devices for use of an uplink communication channel. As a result, a UE may be unable to obtain access to the uplink communication channel if the uplink communication channel is occupied by another wireless communication device. This may result in the UE being unable to transmit a quantity of HARQ feedback bits to a base station (e.g., a base station 110 or another type of network node). The base station may transmit a downlink communication to the UE to trigger the UE to transmit HARQ feedback based at least in part on not receiving the quantity of HARQ feedback bits. The triggering mechanism may include a field in the downlink communication, such as a one-shot HARQ acknowledgement request (one-shot HARQ-ACK request) field set to a 1-value (or another value).

Initially, a base station was enabled to trigger a UE to transmit Type 3 HARQ codebook feedback for all HARQ processes across all active component for the UE. This is referred to as 3GPP Release 16 Type 3 HARQ codebook feedback. The HARQ codebook includes all of the HARQ processes across all active components for the UE. However, advancements in Type 3 HARQ codebook feedback have enabled a base station to more flexibly trigger a UE to provide HARQ feedback for subsets of HARQ processes and/or for subsets of component carriers configured for the UE.

FIG. 3 illustrates an example of 3GPP Release 17 Type 3 HARQ codebook feedback. Note, however, that 3GPP Release 17 Type 3 HARQ codebook feedback (or at least a subset of the techniques of 3GPP Release 17 Type 3 HARQ codebook feedback) may be implemented in later 3GPP releases. In some aspects, 3GPP Release 17 Type 3 HARQ codebook feedback (or at least a subset of the techniques of 3GPP Release 17 Type 3 HARQ codebook feedback) is referred to as enhanced Type 3 HARQ-ACK codebook.

As shown in FIG. 3, a UE 120 may be configured with one or more component carriers. In the example shown in FIG. 3, the UE 120 is configured with two active component carriers: CCO and CC1. However, a UE 120 may be configured with a different quantity of component carriers for 3GPP Release 17 Type 3 HARQ codebook feedback.

As further shown in FIG. 3, in 3GPP Release 17 Type 3 HARQ codebook feedback, the UE 120 may be configured with a plurality of Type 3 HARQ codebooks, including Codebook 0 through Codebook 3. However, other quantities of Type 3 HARQ codebooks are within the scope of the present disclosure. In some aspects, the UE 120 may be configured with up to 8 Type 3 HARQ codebooks, or another quantity of Type 3 HARQ codebooks. The UE 120 may be configured with the plurality of Type 3 HARQ codebooks (e.g., the size of the plurality of Type 3 HARQ codebooks, the quantity of the plurality of Type 3 HARQ codebooks) via radio resource control (RRC) signaling, downlink control information (DCI) signaling, and/or another type of downlink signaling.

Each of the plurality of Type 3 HARQ codebooks contain a respective subset or set of HARQ processes for the UE 120. Moreover, each of the plurality of Type 3 HARQ codebooks may configured for one or more subsets of the active component carriers of the UE 120. For example, the Codebook 0 may be associated with HARQ process identifiers 0-3 for the CCO component carrier, the Codebook 1 may be associated with HARQ process identifiers 4-7 for the CCO component carrier, the Codebook 2 may be associated with the HARQ process identifiers 0-3 for the CC1 component carrier, and the Codebook 3 may be associated with the HARQ process identifiers 4-7 for the CC1 component carrier. While the example in FIG. 3 shows each of the Codebooks 0-3 including a respective subset of HARQ processes that are contained within a component carrier, a Type 3 HARQ codebook may include HARQ processes of a plurality of active component carriers.

In this way, the Codebooks 0-3 enable the UE 120 to provide HARQ feedback to a base station 110 for a subset of the HARQ processes of the UE 120, for a subset of the active component carriers of the UE 120, and/or for a portion of a component carrier of the UE 120. As an example, a base station 110 may trigger the UE 120 to provide HARQ feedback for the Codebooks 1 and 3, for which the UE 120 may transmit HARQ feedback for HARQ process identifiers 4-7 of the CCO component carrier and the HARQ process identifiers 4-7 for the CC1 component carrier. This reduces processing resource consumption of the UE 120 for providing HARQ feedback and reduces wireless network resource usage relative to 3GPP Release 16 Type 3 HARQ codebook feedback. A base station 110 may trigger the UE 120 to provide HARQ feedback for one or more of the Codebooks 0-3 by transmitting, to the UE 120, a downlink communication (e.g., a DCI communication, a physical downlink control channel (PDCCH) communication, or another type of downlink communication) that includes a one-shot HARQ acknowledgement request (one-shot HARQ-ACK request) field set to a 1-value (or another value). The UE 120 transmits HARQ feedback for the HARQ processes of the indicated Type 3 HARQ codebooks.

As indicated above, FIG. 3 is provided as an example. Other examples may differ from what is described with regard to FIG. 3.

As indicated above, a base station may trigger a UE to provide HARQ feedback for one or more Type 3 HARQ codebooks by transmitting a downlink communication that includes a one-shot HARQ acknowledgement request (one-shot HARQ-ACK request) field set to a particular value (e.g., 1-value or another value). However, with the advancements of 3GPP Release 17 Type 3 HARQ codebook feedback (or enhanced Type 3 HARQ codebook feedback), the base station may be unable to use the downlink communication to indicate the Type 3 HARQ codebooks for which the UE is to provide the HARQ feedback. In other words, the base station may use the downlink communication to activate or trigger Type 3 HARQ codebook feedback reporting, but the base station may be unable to indicate or specify which Type 3 HARQ codebooks are triggered in the downlink communication. As a result, the structure or configuration of the downlink communication (e.g., DCI format 1_1 or DCI format 1_2) may not support 3GPP Release 17 Type 3 HARQ codebook feedback (or enhanced Type 3 HARQ codebook feedback).

In some cases, a new DCI field may be introduced. The new DCI field may include a plurality of bits that are dedicated for indicating or triggering Type 3 HARQ codebooks. However, adding a new DCI field to DCI for indicating or triggering Type 3 HARQ codebooks increases the size of the DCI, which increases downlink signaling overhead and downlink radio resource congestion and consumption. Moreover, adding a new DCI field to DCI for indicating or triggering Type 3 HARQ codebooks may result in backwards compatibility issues for some types of UEs.

Some aspects described herein enable a base station (e.g., a base station 110 and/or another type of network node) to reuse or repurpose one or more fields (e.g., one or more existing fields) in a downlink communication for indicating one or more Type 3 HARQ codebooks for Type 3 HARQ codebook feedback triggering. As described herein, the base station may transmit a downlink communication that includes a first field indicating that Type 3 HARQ is triggered. The base station may repurpose one or more fields in the downlink communication to indicate one or more Type 3 HARQ codebooks configured for a UE (e.g., a UE 120). The UE may receive the downlink communication and interpret the repurposed one or more fields to identify the one or more Type 3 HARQ codebooks. The UE may provide HARQ feedback for the one or more Type 3 HARQ codebooks.

In this way, existing fields in a downlink communication (e.g., a DCI communication or another type of downlink communication) may be reused and/or repurposed to indicate Type 3 HARQ codebooks to enable Type 3 HARQ codebook feedback triggering. Reusing existing fields enables Type 3 HARQ codebook feedback triggering without adding new fields to the downlink communication and/or without increasing the size of the downlink communication. This permits Type 3 HARQ codebook feedback to be triggered without increasing downlink signaling overhead and downlink radio resource congestion and consumption. Moreover, reusing existing fields enables Type 3 HARQ codebook feedback triggering without adding new fields to the downlink communication enables Type 3 HARQ codebook feedback triggering without introducing new DCI formats, which reduces the likelihood of backwards compatibility issues. Further, the particular fields that are reused or repurposed may be flexible to accommodate Type 3 HARQ codebook feedback triggering in many different communication scenarios.

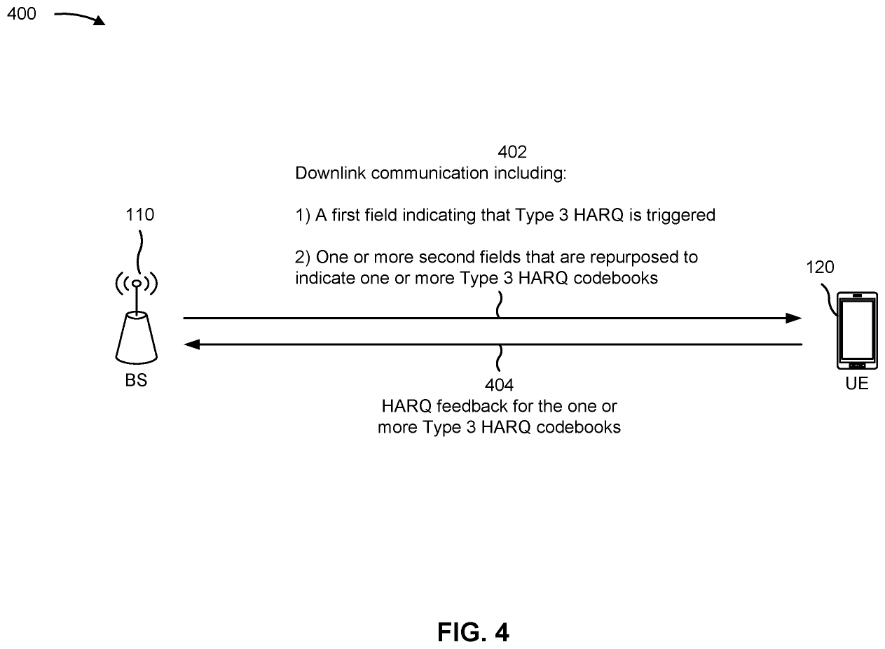

FIG. 4 is a diagram illustrating an example 400 of Type 3 HARQ codebook feedback triggering, in accordance with the present disclosure. As shown in FIG. 4, the example 400 includes communication between a base station 110 (or another type of network node) and a UE 120. The base station 110 and the UE 120 may be included in a wireless network such as the wireless network 100. The base station 110 and the UE 120 may communicate on an access link, which may include an uplink and a downlink. The UE 120 may be configured to provide Type 3 HARQ codebook feedback for one or more downlink communications (e.g., physical downlink shared channel (PDSCH) communications and/or other types of downlink communications) transmitted from the base station 110 to the UE 120.

As shown in FIG. 4, and by reference number 402, the base station 110 may transmit a downlink communication to the UE 120. The UE 120 may receive the downlink communication from the base station 110. The downlink communication may include a PDCCH communication, a DCI communication, and/or another type of downlink communication.

As further shown in FIG. 4, the downlink communication may include a plurality of fields. The plurality of fields may include a first field indicating that Type 3 HARQ is triggered for the UE 120. The first field may be set or configured to include a particular value, such as a 1-value or a 0-value, to indicate that Type 3 HARQ is triggered for the UE 120. The first field may include a one-shot field, such as a one-shot HARQ acknowledgement request (one-shot HARQ-ACK request) field or another type of field.

The plurality of fields may also include one or more second fields for indicating one or more Type 3 HARQ codebooks for which the UE 120 is to provide HARQ feedback. The one or more second fields include one or more DCI fields (e.g., DCI format 1_1 fields, DCI format 1_2 fields) that are used for various downlink transmission parameters and/or scheduling. The base station 110 configures the downlink communication such that the one or more second fields are reused or repurposed (e.g., repurposed from indicating downlink transmission parameters and/or scheduling) to indicate the one or more Type 3 HARQ codebooks. In this way, the one or more Type 3 HARQ codebooks can be indicated in the downlink communication without adding extra bits and/or extra fields to the downlink communication, which would otherwise increase the size and complexity of the downlink communication.

In some aspects, the base station 110 configures the one or more second fields to indicate a single Type 3 HARQ codebook. In some aspects, the base station 110 configures the one or more second fields to indicate a plurality of Type 3 HARQ codebooks. For example, a first subset of the one or more second fields may indicate a first Type 3 HARQ codebook, a second subset of the one or more second fields may indicate a second Type 3 HARQ codebook, and so on. In some aspects, the one or more second fields may support indicating up to four (4) Type 3 HARQ codebooks in the downlink communication. In some aspects, another quantity of Type 3 HARQ codebooks may be indicated in the downlink communication using the one or more second fields. In some aspects, the base station 110 configures the first field (e.g., the one-shot HARQ-ACK request field) to indicate a Type 3 HARQ codebook, such as a default Type 3 HARQ codebook or a Type 3 HARQ codebook with a lowest identifier.

In some aspects, the one or more second fields are based at least in part on whether the downlink communication schedules a downlink transmission to the UE 120, such as a PDSCH transmission or another type of downlink transmission. For example, if the downlink communication does not schedule a downlink transmission to the UE 120, one or more fields that would otherwise be used for the downlink transmission for the PDSCH transmission may be reused and/or repurposed for indicating the one or more Type 3 HARQ codebooks. Accordingly, the one or more second fields may include an MCS field included in the downlink communication, a downlink assignment index (DAI) field included in the downlink communication, an HARQ process number (HPN) field included in the downlink communication, and/or another field that would otherwise be used for the downlink transmission. The one or more second fields may additionally and/or alternatively include other types of fields included in the downlink communication, such as a carrier indicator field (CIF), a bandwidth part (BWP) indicator field (BWPIF), a virtual resource block to physical resource block (VRB-to-PRB) mapping field, a PRB bunding size indicator (PRBB SI) field, and/or a zero power channel state information reference signal (ZP CSI-RS) trigger field, among other examples.

If the downlink communication schedules a PDSCH transmission, the PDSCH transmission fields in the downlink communication may be used for scheduling the PDSCH transmission, and one or more other fields in the downlink communication may be reused and/or repurposed as the one or more second fields. In some aspects, the one or more second fields may be based at least in part on one or more configurations, capabilities, and/or parameters associated with the UE 120 and/or the base station 110. For example, if the UE 120 is not configured with cross carrier scheduling (e.g., cross carrier scheduling in a CrossCarrierSchedulingConfig information element (IE) is not activated for the UE 120), the CIF may be used as the one or more second fields to indicate the one or more Type 3 HARQ codebooks. The bits of the CIF may be repurposed to indicate a value associated with the one or more Type 3 HARQ codebooks because the base station 110 does not configure cross carrier scheduling for the UE 120. In some aspects, one or more other fields in the downlink communication are repurposed in combination with the CIF to indicate the one or more Type 3 HARQ codebooks.

As another example, if the UE 120 is configured with cross carrier scheduling (e.g., cross carrier scheduling in a CrossCarrierSchedulingConfig IE is activated for the UE 120), the CIF may be used as the one or more second fields to indicate the one or more Type 3 HARQ codebooks in implementations in which the base station 110 schedules the PDSCH transmission in a cell of the base station 110. In these aspects, a first bit of the CIF is set or configured to a 1-value. The first bit is associated with an “own” sub-field of the CIF, and the 1-value indicates that “own” is set to true, which indicates that the base station 110 is scheduling the PDSCH transmission in a cell of the base station 110. Accordingly, the remaining bits (e.g., two (2) bits) in the CIF may be repurposed to indicate the one or more Type 3 HARQ codebooks.

In some aspects, the remaining bits in the CIF are configured to indicate a first one or more Type 3 HARQ codebooks configured for the UE 120 (e.g., the one or more Type 3 HARQ codebooks with the lowest codebook identifiers). In some aspects, the remaining bits in the CIF are configured to indicate one or more default Type 3 HARQ codebooks for the UE 120. The default Type 3 HARQ codebook(s) may be associated with any codebook identifier. For example a Codebook 2 may be assigned as a default Type 3 HARQ codebook 1, and a Codebook 4 may be assigned as a default Type 3 HARQ codebook 2. The UE 120 transmits HARQ feedback for the default Type 3 HARQ codebook 1 (e.g., Codebook 2) based at least in part on the remaining bits in the CIF being configured to indicate a value associated with the default Type 3 HARQ codebook 1. Similarly, the UE 120 transmits HARQ feedback for the default Type 3 HARQ codebook 2 (e.g., Codebook 4) based at least in part on the remaining bits in the CIF being configured to indicate a value associated with the default Type 3 HARQ codebook 2.

In some aspects, if the UE 120 does not support active BWP switching via DCI (or if active BWP switching is not configured for the UE 120), the BWPIF may be used as the one or more second fields to indicate the one or more Type 3 HARQ codebooks. In some aspects, one or more other fields in the downlink communication are used in combination with the BWPIF to indicate the one or more Type 3 HARQ codebooks. The base station 110 may configure the BWPIF to be repurposed to indicate the one or more Type 3 HARQ codebooks because the base station 110 does not need to indicate BWP switching to the UE 120.

The quantity of Type 3 HARQ codebook candidates that can be indicated by the BWPIF may be based at least in part on a quantity of bits included in the BWPIF. For example, if the BWPIF includes one (1) bit, the BWPIF may indicate one of up to two (2) Type 3 HARQ codebook candidates. As another example, if the BWPIF includes two (2) bits, the BWPIF may indicate one of up to four (4) Type 3 HARQ codebook candidates. The Type 3 HARQ codebook candidates may include the lowest Type 3 HARQ codebook identifiers configured for the UE 120 or default Type 3 HARQ codebook identifiers configured for the UE 120.

In some aspects, if a Resource Allocation Type 0 (e.g., an NR Resource Allocation Type 0) is configured for the UE 120, the one or more second fields may include the VRB-to-PRB mapping field. The VRB-to-PRB mapping field may be included in the downlink communication based at least in part on the Resource Allocation Type for the UE 120 being Type 0. In some aspects, one or more other fields in the downlink communication are used in combination with the VRB-to-PRB mapping field to indicate the one or more Type 3 HARQ codebooks. For example, if cross carrier scheduling is configured for the UE 120 and the first bit of the CIF is set to a 1-value (e.g., “own” is set to true), the remaining bits may be repurposed to indicate the one or more Type 3 HARQ codebooks in combination with the one (1) bit of the VRB-to-PRB mapping field (for a total of three (3) bits).

As another example, if the UE 120 does not support active BWP switching via DCI (or if active BWP switching is not configured for the UE 120), the BWPIF (including one (1) bit) may be used in combination with the VRB-to-PRB mapping field and the CIF for a total of four (4) bits that may be repurposed to indicate the one or more Type 3 HARQ codebooks. As another example, if the UE 120 does not support active BWP switching via DCI (or if active BWP switching is not configured for the UE 120), and if the first bit of the CIF is set to a 0-value (e.g., “own” is set to false — indicating that the remaining bits are to be used for cross carrier scheduling), the BWPIF (including two (2) bits) may be used in combination with the VRB-to-PRB mapping field for a total of three (3) bits that may be repurposed to indicate the one or more Type 3 HARQ codebooks.

As another example, if the UE 120 does not support active BWP switching via DCI (or if active BWP switching is not configured for the UE 120), if the first bit of the CIF is set to a 0-value (e.g., “own” is set to false—indicating that the remaining bits are to be used for cross carrier scheduling), and if PRB bundling is not configured for the UE 120 (or PRB bundling is set to static bundling for the UE 120), the BWPIF (including two (2) bits) may be used in combination with the VRB-to-PRB mapping field and a PRBBSI field (one (1) bit) for a total of four (4) bits that may be repurposed to indicate the one or more Type 3 HARQ codebooks.

In some aspects, if zero (0) aperiodic ZP CSI-RS resource sets are configured for the UE 120, the ZP CSI-RS trigger field may be repurposed to indicate the one or more Type 3 HARQ codebooks in the downlink communication. In some aspects, the ZP CSI-RS trigger field may be used in combination with one or more other fields in the downlink communication (e.g., the CIF, the BWPIF, the VRB-to-PRB mapping field, the PRBBSI field, and/or another field) to indicate the one or more Type 3 HARQ codebooks in the downlink communication.

In some aspects, the downlink communication schedules the PDSCH transmission to include one or more codewords (or transport blocks). In some aspects, the UE 120 is configured with a parameter that indicates a maximum number of codewords that can be scheduled by DCI for the UE 120. The parameter may include maxNrofCodeWordsScheduledByDCI or another parameter. If the maxNrofCodeWordsScheduledByDCI parameter is configured as two (2) for the UE 20, the downlink communication includes a first set of fields for a first codeword and a second set of fields for the second codeword to support the maximum number of codewords for the UE 120. If the downlink communication only schedules one (1) codewords of the two (2) possible codewords, the base station 110 may use one or more of the second set of fields associated with the second codeword for indicating the one or more Type 3 HARQ codewords. In other words, if the second set of fields are to be unused in the downlink communication (e.g., because the downlink communication does not schedule a second codeword for the PDSCH transmission), the base station 110 may repurpose the second set of fields to indicate the one or more Type 3 HARQ codewords.

The second set of fields may include an MCS field for the second codeword. The MCS field may include four (4) bits or another quantity of bits that may be repurposed to indicate the one or more Type 3 HARQ codebooks. Moreover, one or more other fields in the downlink communication may be repurposed to indicate whether the second set of fields should be interpreted as being valid and associated with a second codeword, or whether the second set of fields should be interpreted as indicating one or more Type 3 HARQ codebooks. The one or more other fields may include the VRB-to-PRB mapping field, the BWPIF field, the CIF field, and/or another field.

As further shown in FIG. 4, and by reference number 404, the UE 120 transmits HARQ feedback for the one or more Type 3 HARQ codebooks indicated by the downlink communication. The base station 110 may receive the HARQ feedback from the UE 120. In particular, the HARQ feedback includes HARQ feedback for each of the HARQ processes associated with the one or more Type 3 HARQ codebooks. The HARQ feedback may include, for example, an acknowledgement (ACK) or a negative ACK (NACK).

In some aspects, the UE 120 identifies the one or more Type 3 HARQ codebooks based at least in part on interpreting the one or more second fields in the downlink communication as indicating the one or more Type 3 HARQ codebooks. In some aspects, the UE 120 interprets the one or more second fields in the downlink communication as indicating the one or more Type 3 HARQ codebooks based at least in part on a configuration. The UE 120 may be configured with the configuration prior to deployment into the wireless network and/or after being deployed into the wireless network. For example, the base station 110 may generate the configuration and may transmit the configuration to the UE 120 (e.g., in a DCI communication, an RRC communication, and/or another type of downlink communication). The base station 110 may generate the configuration based at least in part on a configuration of the UE 120, a UE capability of the UE 120, assistance information associated with the UE 120, and/or based on another factor. For example, the base station 110 may indicate which fields are to be repurposed to indicate the one or more Type 3 HARQ codebooks based at least in part on whether the UE 120 supports cross carrier scheduling, active bandwidth part switching, and/or another capability.

In some aspects, the base station 110 schedules and performs retransmissions to the UE 120 based at least in part on the HARQ feedback received from the UE 120. For example, the base station 110 may perform a retransmission of a portion of PDSCH transmission associated with a Type 3 HARQ codebook for which the base station 110 receives a NACK from the UE 120.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with Type 3 HARQ codebook feedback triggering.

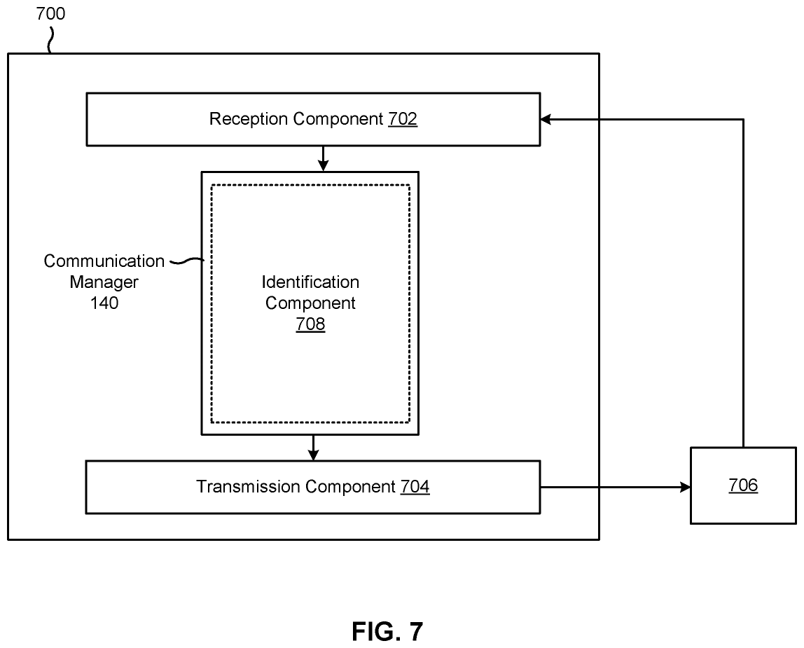

As shown in FIG. 5, in some aspects, process 500 may include receiving a downlink communication that includes: a first field indicating that Type 3 HARQ is triggered, and one or more second fields that are repurposed to indicate one or more Type 3 HARQ codebooks configured for the UE (block 510). For example, the UE (e.g., using communication manager 140 and/or reception component 702, depicted in FIG. 7) may receive a downlink communication that includes: a first field indicating that Type 3 HARQ is triggered, and one or more second fields that are repurposed to indicate one or more Type 3 HARQ codebooks configured for the UE, as described above.

As further shown in FIG. 5, in some aspects, process 500 may include transmitting HARQ feedback for the one or more Type 3 HARQ codebooks (block 520). For example, the UE (e.g., using communication manager 140 and/or transmission component 704, depicted in FIG. 7) may transmit HARQ feedback for the one or more Type 3 HARQ codebooks, as described above.

Process 500 may include additional aspects, such as any single aspect or any combination of aspects described below and/or in connection with one or more other processes described elsewhere herein.

In a first aspect, each of the one or more Type 3 HARQ codebooks includes a subset of HARQ processes that are associated with a component carrier assigned to the UE.

In a second aspect, alone or in combination with the first aspect, the one or more Type 3 HARQ codebooks are a subset of a plurality of Type 3 HARQ codebooks configured for the UE.

In a third aspect, alone or in combination with one or more of the first and second aspects, the downlink communication schedules a PDSCH transmission, wherein cross carrier scheduling is not activated for the UE, and wherein the one or more second fields that are repurposed to indicate the one or more Type 3 HARQ codebooks include a CIF included in the downlink communication.

In a fourth aspect, alone or in combination with one or more of the first through third aspects, the downlink communication schedules a PDSCH transmission, wherein cross carrier scheduling is activated for the UE, wherein the one or more second fields that are repurposed to indicate the one or more Type 3 HARQ codebooks include a CIF included in the downlink communication, wherein a first bit of the CIF is set to a 1-value, and wherein a plurality of second bits of the CIF are repurposed to indicate the one or more Type 3 HARQ codebooks.

In a fifth aspect, alone or in combination with one or more of the first through fourth aspects, the plurality of second bits indicate the one or more Type 3 HARQ codebooks based at least in part on the one or more Type 3 HARQ codebooks being default Type 3 HARQ codebooks for the UE.

In a sixth aspect, alone or in combination with one or more of the first through fifth aspects, the downlink communication schedules a PDSCH transmission, wherein the UE does not support active BWP switching via DCI, and wherein the one or more second fields that are repurposed to indicate the one or more Type 3 HARQ codebooks include a BWPIF included in the downlink communication.

In a seventh aspect, alone or in combination with one or more of the first through sixth aspects, the one or more Type 3 HARQ codebooks are associated with lowest Type 3 HARQ codebook identifiers for the UE, or wherein the one or more Type 3 HARQ codebooks are default Type 3 HARQ codebooks for the UE.

In an eighth aspect, alone or in combination with one or more of the first through seventh aspects, the downlink communication schedules a PDSCH transmission, wherein Resource Allocation Type 0 is configured for the UE, wherein the one or more second fields that are repurposed to indicate the one or more Type 3 HARQ codebooks include a VRB-to-PRB mapping field included in the downlink communication, and a CIF included in the downlink communication.

In a ninth aspect, alone or in combination with one or more of the first through eighth aspects, crossing carrier scheduling is activated for the UE, wherein a first bit of the CIF is set to a 1-value, and wherein the one or more Type 3 HARQ codebooks are indicated by a combination of a plurality of second bits included in the CIF and a first bit included in the VRB-to-PRB mapping field.

In a tenth aspect, alone or in combination with one or more of the first through ninth aspects, the downlink communication schedules a PDSCH transmission, wherein Resource Allocation Type 0 is configured for the UE, wherein cross carrier scheduling is configured for the UE, wherein a CIF, included in the downlink communication, includes a first bit set to a 0-value, wherein the UE does not support active BWP switching via DCI, and wherein the one or more second fields that are repurposed to indicate the one or more Type 3 HARQ codebooks include a BWPIF included in the downlink communication, and a VRB-to-PRB mapping field included in the downlink communication.

In an eleventh aspect, alone or in combination with one or more of the first through tenth aspects, the downlink communication schedules a PDSCH transmission, wherein Resource Allocation Type 0 is configured for the UE, wherein cross carrier scheduling is configured for the UE, wherein a CIF, included in the downlink communication, includes a first bit set to a 0-value, wherein the UE does not support active BWP switching via DCI, wherein PRB bundling is not configured for the UE, and wherein the one or more second fields that are repurposed to indicate the one or more Type 3 HARQ codebooks include a BWPIF included in the downlink communication, and a PRB PRBBSI field included in the downlink communication.

In a twelfth aspect, alone or in combination with one or more of the first through eleventh aspects, the downlink communication schedules a PDSCH transmission, wherein the UE is configured with zero (0) aperiodic ZP CSI-RS resource sets, and wherein the one or more second fields that are repurposed to indicate the one or more Type 3 HARQ codebooks include a ZP CSI-RS trigger field included in the downlink communication.

In a thirteenth aspect, alone or in combination with one or more of the first through twelfth aspects, the one or more second fields that are repurposed to indicate the one or more Type 3 HARQ codebooks include at least one of a VRB-to-PRB mapping field included in the downlink communication, a PRBBSI field included in the downlink communication, or a CIF included in the downlink communication.

In a fourteenth aspect, alone or in combination with one or more of the first through thirteenth aspects, a maximum number of codewords scheduled by downlink control information (maxNrofCodeWordsScheduledByDCl) parameter is configured as two (2) for the UE, wherein the downlink communication schedules a PDSCH transmission, wherein the PDSCH transmission includes a single codeword, and wherein the one or more second fields that are repurposed to indicate the one or more Type 3 HARQ codebooks include an MCS field, that is configured to be used for a second codeword, included in the downlink communication.

In a fifteenth aspect, alone or in combination with one or more of the first through fourteenth aspects, one or more other fields included in the downlink communication are repurposed to indicate that the MCS field is repurposed to indicate the one or more Type 3 HARQ codebooks, and wherein the one or more other fields include at least one of a VRB-to-PRB mapping field included in the downlink communication, a BWPIF included in the downlink communication, or a CIF included in the downlink communication.

In a sixteenth aspect, alone or in combination with one or more of the first through fifteenth aspects, the downlink communication does not schedule a PDSCH transmission, wherein the one or more second fields that are repurposed to indicate the one or more Type 3 HARQ codebooks include at least one of an MCS field included in the downlink communication, a DAI field included in the downlink communication, an HPN field included in the downlink communication, a VRB-to-PRB mapping field included in the downlink communication, a BWPIF included in the downlink communication, a CIF included in the downlink communication, a PRBBSI field included in the downlink communication, or a ZP CSI-RS trigger field included in the downlink communication.

In a seventeenth aspect, alone or in combination with one or more of the first through sixteenth aspects, the one or more second fields, that are repurposed to indicate the one or more Type 3 HARQ codebooks, indicate a plurality of Type 3 HARQ codebooks.

In an eighteenth aspect, alone or in combination with one or more of the first through seventeenth aspects, process 500 includes receiving a configuration that indicates the one or more second fields that are repurposed to indicate one or more Type 3 HARQ codebooks.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with Type 3 HARQ codebook feedback triggering.

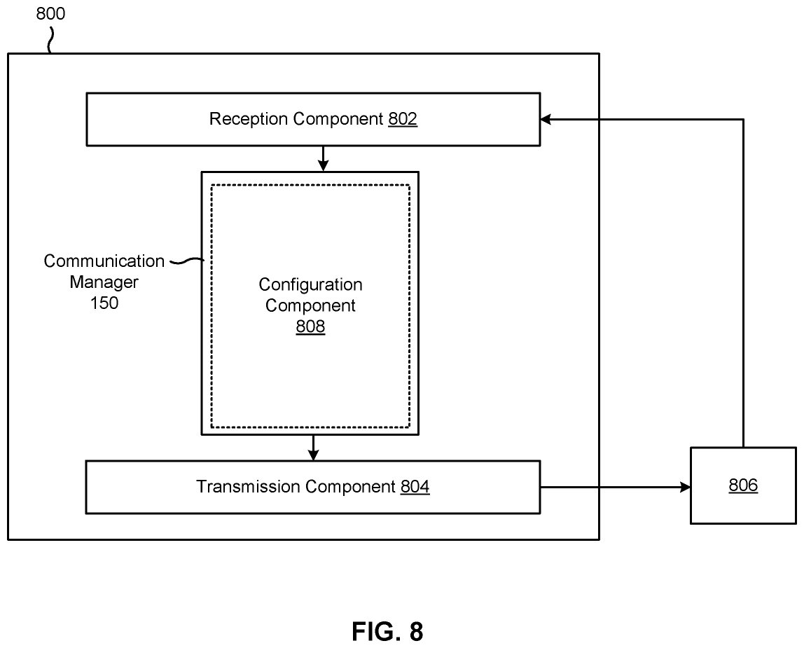

As shown in FIG. 6, in some aspects, process 600 may include transmitting a downlink communication that includes: a first field indicating that Type 3 HARQ is triggered, and one or more second fields that are repurposed to indicate one or more Type 3 HARQ codebooks configured for a UE (block 610). For example, the base station (e.g., using communication manager 150 and/or transmission component 804, depicted in FIG. 8) may transmit a downlink communication that includes: a first field indicating that Type 3 HARQ is triggered, and one or more second fields that are repurposed to indicate one or more Type 3 HARQ codebooks configured for a UE, as described above.

As further shown in FIG. 6, in some aspects, process 600 may include receiving, from the UE, HARQ feedback for the one or more Type 3 HARQ codebooks (block 620). For example, the base station (e.g., using communication manager 150 and/or reception component 802, depicted in FIG. 8) may receive, from the UE, HARQ feedback for the one or more Type 3 HARQ codebooks, as described above.

Process 600 may include additional aspects, such as any single aspect or any combination of aspects described below and/or in connection with one or more other processes described elsewhere herein.

In a first aspect, each of the one or more Type 3 HARQ codebooks includes a subset of HARQ processes that are associated with a component carrier assigned to the UE.

In a second aspect, alone or in combination with the first aspect, the one or more Type 3 HARQ codebooks are a subset of a plurality of Type 3 HARQ codebooks configured for the UE.

In a third aspect, alone or in combination with one or more of the first and second aspects, the downlink communication schedules a PDSCH transmission, wherein cross carrier scheduling is not activated for the UE, and wherein the one or more second fields that are repurposed to indicate the one or more Type 3 HARQ codebooks include a CIF included in the downlink communication.

In a fourth aspect, alone or in combination with one or more of the first through third aspects, the downlink communication schedules a PDSCH transmission, wherein cross carrier scheduling is activated for the UE, wherein the one or more second fields that are repurposed to indicate the one or more Type 3 HARQ codebooks include a CIF included in the downlink communication, wherein a first bit of the CIF is set to a 1-value, and wherein a plurality of second bits of the CIF are repurposed to indicate the one or more Type 3 HARQ codebooks.

In a fifth aspect, alone or in combination with one or more of the first through fourth aspects, the plurality of second bits indicate the one or more Type 3 HARQ codebooks based at least in part on the one or more Type 3 HARQ codebooks being default Type 3 HARQ codebooks for the UE.

In a sixth aspect, alone or in combination with one or more of the first through fifth aspects, the downlink communication schedules a PDSCH transmission, wherein the UE does not support active BWP switching via DCI, and wherein the one or more second fields that are repurposed to indicate the one or more Type 3 HARQ codebooks include a BWPIF included in the downlink communication.

In a seventh aspect, alone or in combination with one or more of the first through sixth aspects, the one or more Type 3 HARQ codebooks are associated with lowest Type 3 HARQ codebook identifiers for the UE, or wherein the one or more Type 3 HARQ codebooks are default Type 3 HARQ codebooks for the UE.

In an eighth aspect, alone or in combination with one or more of the first through seventh aspects, the downlink communication schedules a PDSCH transmission, wherein Resource Allocation Type 0 is configured for the UE, wherein the one or more second fields that are repurposed to indicate the one or more Type 3 HARQ codebooks include a VRB-to-PRB mapping field included in the downlink communication, and a CIF included in the downlink communication.

In a ninth aspect, alone or in combination with one or more of the first through eighth aspects, crossing carrier scheduling is activated for the UE, wherein a first bit of the CIF is set to a 1-value, and wherein the one or more Type 3 HARQ codebooks are indicated by a combination of a plurality of second bits included in the CIF and a first bit included in the VRB-to-PRB mapping field.

In a tenth aspect, alone or in combination with one or more of the first through ninth aspects, the downlink communication schedules a PDSCH transmission, wherein Resource Allocation Type 0 is configured for the UE, wherein cross carrier scheduling is configured for the UE, wherein a CIF, included in the downlink communication, includes a first bit set to a 0-value, wherein the UE does not support active BWP switching via DCI, and wherein the one or more second fields that are repurposed to indicate the one or more Type 3 HARQ codebooks include a BWPIF included in the downlink communication, and a VRB-to-PRB mapping field included in the downlink communication.

In an eleventh aspect, alone or in combination with one or more of the first through tenth aspects, the downlink communication schedules a PDSCH transmission, wherein Resource Allocation Type 0 is configured for the UE, wherein cross carrier scheduling is configured for the UE, wherein a CIF, included in the downlink communication, includes a first bit set to a 0-value, wherein the UE does not support active BWP switching via DCI, wherein PRB bundling is not configured for the UE, and wherein the one or more second fields that are repurposed to indicate the one or more Type 3 HARQ codebooks include a BWPIF included in the downlink communication, and a PRBBSI field included in the downlink communication.

In a twelfth aspect, alone or in combination with one or more of the first through eleventh aspects, the downlink communication schedules a PDSCH transmission, wherein the UE is configured with zero (0) aperiodic ZP CSI-RS resource sets, and wherein the one or more second fields that are repurposed to indicate the one or more Type 3 HARQ codebooks include a ZP CSI-RS trigger field included in the downlink communication.

In a thirteenth aspect, alone or in combination with one or more of the first through twelfth aspects, the one or more second fields that are repurposed to indicate the one or more Type 3 HARQ codebooks include at least one of a VRB-to-PRB mapping field included in the downlink communication, a PRBBSI field included in the downlink communication, or a CIF included in the downlink communication.

In a fourteenth aspect, alone or in combination with one or more of the first through thirteenth aspects, a maximum number of codewords scheduled by downlink control information (maxNrofCodeWordsScheduledByDCl) parameter is configured as two (2) for the UE, wherein the downlink communication schedules a PDSCH transmission, wherein the PDSCH transmission includes a single codeword, and wherein the one or more second fields that are repurposed to indicate the one or more Type 3 HARQ codebooks include an MCS field, that is configured to be used for a second codeword, included in the downlink communication.

In a fifteenth aspect, alone or in combination with one or more of the first through fourteenth aspects, one or more other fields included in the downlink communication are repurposed to indicate that the MCS field is repurposed to indicate the one or more Type 3 HARQ codebooks, and wherein the one or more other fields include at least one of a VRB-to-PRB mapping field included in the downlink communication, a BWPIF included in the downlink communication, or a CIF included in the downlink communication.

In a sixteenth aspect, alone or in combination with one or more of the first through fifteenth aspects, the downlink communication does not schedule a PDSCH transmission, wherein the one or more second fields that are repurposed to indicate the one or more Type 3 HARQ codebooks include at least one of an MCS field included in the downlink communication, a DAI field included in the downlink communication, an HPN field included in the downlink communication, a VRB-to-PRB mapping field included in the downlink communication, a BWPIF included in the downlink communication, a CIF included in the downlink communication, a PRBB SI field included in the downlink communication, or a ZP CSI-RS trigger field included in the downlink communication.

In a seventeenth aspect, alone or in combination with one or more of the first through sixteenth aspects, the one or more second fields, that are repurposed to indicate the one or more Type 3 HARQ codebooks, indicate a plurality of Type 3 HARQ codebooks.

In an eighteenth aspect, alone or in combination with one or more of the first through seventeenth aspects, process 600 includes transmitting a configuration that indicates the one or more second fields that are repurposed to indicate one or more Type 3 HARQ codebooks.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE 120, or a UE 120 may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include an identification component 708, among other examples.

In some aspects, the apparatus 700 may be configured to perform one or more operations described herein in connection with FIGS. 3 and 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE 120 described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE 120 described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE 120 described in connection with FIG. 2. In some aspects, the transmission component 704 may be co-located with the reception component 702 in a transceiver.

In some aspects, the reception component 702 may receive (e.g., from the apparatus 706) a downlink communication. The downlink communication may include a first field indicating that Type 3 HARQ is triggered, and one or more fields that are repurposed to indicate one or more Type 3 HARQ codebooks configured for the apparatus 700. In some aspects, the transmission component 704 may transmit (e.g., to the apparatus 706) HARQ feedback for the one or more Type 3 HARQ codebooks.

In some aspects, the identification component 708 may identify the one or more Type 3 HARQ codebooks based at least in part on the one or more fields that are repurposed to indicate the one or more Type 3 HARQ codebooks. In some aspects, the reception component 702 receives (e.g., from the apparatus 706) a configuration that indicates the one or more fields that are repurposed to indicate one or more Type 3 HARQ codebooks. The identification component 708 may interpret the one or more fields, based at least in part on the configuration, to identify the one or more Type 3 HARQ codebooks.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station 110, or a base station 110 may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include a configuration component 808, among other examples.

In some aspects, the apparatus 800 may be configured to perform one or more operations described herein in connection with FIGS. 3 and 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station 110 described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station 110 described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station 110 described in connection with FIG. 2. In some aspects, the transmission component 804 may be co-located with the reception component 802 in a transceiver.

In some aspects, the transmission component 804 may transmit (e.g., to the apparatus 806) a downlink communication. The downlink communication may include a first field indicating that Type 3 HARQ is triggered, and one or more fields that are repurposed to indicate one or more Type 3 HARQ codebooks configured for the apparatus 806. In some aspects, the reception component 802 may receive (e.g., from the apparatus 806) HARQ feedback for the one or more Type 3 HARQ codebooks.

In some aspects, the configuration component 808 may configure the one or more fields in the downlink communication to be repurposed to indicate the one or more Type 3 HARQ codebooks. In some aspects, the transmission component 804 transmits (e.g., to the apparatus 806) a configuration that indicates that the one or more fields are repurposed to indicate one or more Type 3 HARQ codebooks. The configuration component 808 may generate the configuration.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving a downlink communication that includes: a first field indicating that Type 3 hybrid automatic repeat request (HARQ) is triggered, and one or more second fields that are repurposed to indicate one or more Type 3 HARQ codebooks configured for the UE; and transmitting HARQ feedback for the one or more Type 3 HARQ codebooks.

Aspect 2: The method of Aspect 1, wherein each of the one or more Type 3 HARQ codebooks includes a subset of HARQ processes that are associated with one or me component carriers assigned to the UE.

Aspect 3: The method of Aspect 1 or 2, wherein the one or more Type 3 HARQ codebooks are a subset of a plurality of Type 3 HARQ codebooks configured for the UE.

Aspect 4: The method of one or more of Aspects 1-3, wherein the downlink communication schedules a physical downlink shared channel (PDSCH) transmission; wherein cross carrier scheduling is not activated for the UE; and wherein the one or more second fields that are repurposed to indicate the one or more Type 3 HARQ codebooks include a carrier indicator field (CIF) included in the downlink communication.

Aspect 5: The method of one or more of Aspects 1-4, wherein the downlink communication schedules a physical downlink shared channel (PDSCH) transmission; wherein cross carrier scheduling is activated for the UE; wherein the one or more second fields that are repurposed to indicate the one or more Type 3 HARQ codebooks include a carrier indicator field (CIF) included in the downlink communication; wherein a first bit of the CIF is set to a 1-value; and wherein a plurality of second bits of the CIF are repurposed to indicate the one or more Type 3 HARQ codebooks.

Aspect 6: The method of Aspect 5, wherein the plurality of second bits indicate the one or more Type 3 HARQ codebooks based at least in part on the one or more Type 3 HARQ codebooks being default Type 3 HARQ codebooks for the UE.

Aspect 7: The method of one or more of Aspects 1-6, wherein the downlink communication schedules a physical downlink shared channel (PDSCH) transmission; wherein the UE does not support active bandwidth part (BWP) switching via downlink control information (DCI); and wherein the one or more second fields that are repurposed to indicate the one or more Type 3 HARQ codebooks include a BWP indicator field (BWPIF) included in the downlink communication.

Aspect 8: The method of Aspect 7, wherein the one or more Type 3 HARQ codebooks are associated with lowest Type 3 HARQ codebook identifiers for the UE, or wherein the one or more Type 3 HARQ codebooks are default Type 3 HARQ codebooks for the UE.

Aspect 9: The method of one or more or Aspects 1-8, wherein the downlink communication schedules a physical downlink shared channel (PDSCH) transmission; wherein Resource Allocation Type 0 is configured for the UE; wherein the one or more second fields that are repurposed to indicate the one or more Type 3 HARQ codebooks include: a virtual resource block to physical resource block (VRB-to-PRB) mapping field included in the downlink communication, and a carrier indicator field (CIF) included in the downlink communication.

Aspect 10: The method of Aspect 9, wherein cross carrier scheduling is activated for the UE; wherein a first bit of the CIF is set to a 1-value; and wherein the one or more Type 3 HARQ codebooks are indicated by a combination of a plurality of second bits included in the CIF and a first bit included in the VRB-to-PRB mapping field.

Aspect 11: The method of one or more of Aspects 1-10, wherein the downlink communication schedules a physical downlink shared channel (PDSCH) transmission; wherein Resource Allocation Type 0 is configured for the UE; wherein cross carrier scheduling is configured for the UE; wherein a carrier indicator field (CIF), included in the downlink communication, includes a first bit set to a 0-value; wherein the UE does not support active bandwidth part (BWP) switching via downlink control information (DCI); and wherein the one or more second fields that are repurposed to indicate the one or more Type 3 HARQ codebooks include: a BWP indicator field (BWPIF) included in the downlink communication, and a virtual resource block to physical resource block (VRB-to-PRB) mapping field included in the downlink communication.

Aspect 12: The method of one or more of Aspects 1-11, wherein the downlink communication schedules a physical downlink shared channel (PDSCH) transmission; wherein Resource Allocation Type 0 is configured for the UE; wherein cross carrier scheduling is configured for the UE; wherein a carrier indicator field (CIF), included in the downlink communication, includes a first bit set to a 0-value; wherein the UE does not support active bandwidth part (BWP) switching via downlink control information (DCI); wherein physical resource block (PRB) bundling is not configured for the UE; and wherein the one or more second fields that are repurposed to indicate the one or more Type 3 HARQ codebooks include: a BWP indicator field (BWPIF) included in the downlink communication, and a PRB bundling size indicator (PRBBSI) field included in the downlink communication.

Aspect 13: The method of one or more of Aspects 1-12, wherein the downlink communication schedules a physical downlink shared channel (PDSCH) transmission; wherein the UE is configured with zero (0) aperiodic zero power channel state information reference signal (ZP CSI-RS) resource sets; and wherein the one or more second fields that are repurposed to indicate the one or more Type 3 HARQ codebooks include a ZP CSI-RS trigger field included in the downlink communication.

Aspect 14: The method of Aspect 13, wherein the one or more second fields that are repurposed to indicate the one or more Type 3 HARQ codebooks include at least one of: a virtual resource block to physical resource block (VRB-to-PRB) mapping field included in the downlink communication, a PRB bundling size indicator (PRBBSI) field included in the downlink communication, or a carrier indicator field (CIF) included in the downlink communication.

Aspect 15: The method of one or more of Aspects 1-14, wherein a maximum number of codewords scheduled by downlink control information (maxNrofCodeWordsScheduledByDCI) parameter is configured as two (2) for the UE; wherein the downlink communication schedules a physical downlink shared channel (PDSCH) transmission; wherein the PDSCH transmission includes a single codeword; and wherein the one or more second fields that are repurposed to indicate the one or more Type 3 HARQ codebooks include a modulation coding scheme (MCS) field, that is configured to be used for a second codeword, included in the downlink communication.

Aspect 16: The method of Aspect 15, wherein one or more other fields included in the downlink communication are repurposed to indicate that the MCS field is repurposed to indicate the one or more Type 3 HARQ codebooks; and wherein the one or more other fields include at least one of: a virtual resource block to physical resource block (VRB-to-PRB) mapping field included in the downlink communication, a bandwidth part indicator field (BWPIF) included in the downlink communication, or a carrier indicator field (CIF) included in the downlink communication.

Aspect 17: The method of one or more of Aspects 1-16 wherein the downlink communication does not schedule a physical downlink shared channel (PDSCH) transmission; wherein the one or more second fields that are repurposed to indicate the one or more Type 3 HARQ codebooks include at least one of: a modulation coding scheme (MCS) field included in the downlink communication, a downlink assignment index (DAI) field included in the downlink communication, an HARQ process number (HPN) field included in the downlink communication, a virtual resource block to physical resource block (VRB-to-PRB) mapping field included in the downlink communication, a bandwidth part indicator field (BWPIF) included in the downlink communication, a carrier indicator field (CIF) included in the downlink communication, a PRB bundling size indicator (PRBB SI) field included in the downlink communication, or a zero power channel state information reference signal (ZP CSI-RS) trigger field included in the downlink communication.

Aspect 18: The method of Aspect 17, wherein the one or more second fields, that are repurposed to indicate the one or more Type 3 HARQ codebooks, indicate a plurality of Type 3 HARQ codebooks.

Aspect 19: The method of one or more of Aspects 1-18, further comprising: receiving a configuration that indicates the one or more second fields that are repurposed to indicate one or more Type 3 HARQ codebooks.

Aspect 20: A method of wireless communication performed by a base station, comprising: transmitting a downlink communication that includes: a first field indicating that Type 3 hybrid automatic repeat request (HARQ) is triggered, and one or more second fields that are repurposed to indicate one or more Type 3 HARQ codebooks configured for a user equipment (UE); and receiving, from the UE, HARQ feedback for the one or more Type 3 HARQ codebooks.

Aspect 21: The method of Aspect 20, wherein each of the one or more Type 3 HARQ codebooks includes a subset of HARQ processes that are associated with a component carrier assigned to the UE.

Aspect 22: The method of Aspect 20 or 21, wherein the one or more Type 3 HARQ codebooks are a subset of a plurality of Type 3 HARQ codebooks configured for the UE.

Aspect 23: The method of one or me of Aspects 20-22, wherein the downlink communication schedules a physical downlink shared channel (PDSCH) transmission; wherein cross carrier scheduling is not activated for the UE; and wherein the one or more second fields that are repurposed to indicate the one or more Type 3 HARQ codebooks include a carrier indicator field (CIF) included in the downlink communication.

Aspect 24: The method of one or more of Aspects 20-23, wherein the downlink communication schedules a physical downlink shared channel (PDSCH) transmission; wherein cross carrier scheduling is activated for the UE; wherein the one or more second fields that are repurposed to indicate the one or more Type 3 HARQ codebooks include a carrier indicator field (CIF) included in the downlink communication; wherein a first bit of the CIF is set to a 1-value; and wherein a plurality of second bits of the CIF are repurposed to indicate the one or more Type 3 HARQ codebooks.

Aspect 25: The method of Aspect 24, wherein the plurality of second bits indicate the one or more Type 3 HARQ codebooks based at least in part on the one or more Type 3 HARQ codebooks being default Type 3 HARQ codebooks for the UE.

Aspect 26: The method of one or more of Aspects 20-25, wherein the downlink communication schedules a physical downlink shared channel (PDSCH) transmission; wherein the UE does not support active bandwidth part (BWP) switching via downlink control information (DCI); and wherein the one or more second fields that are repurposed to indicate the one or more Type 3 HARQ codebooks include a BWP indicator field (BWPIF) included in the downlink communication.

Aspect 27: The method of Aspect 26, wherein the one or more Type 3 HARQ codebooks are associated with lowest Type 3 HARQ codebook identifiers for the UE, or wherein the one or more Type 3 HARQ codebooks are default Type 3 HARQ codebooks for the UE.

Aspect 28: The method of one or more of Aspects 20-27, wherein the downlink communication schedules a physical downlink shared channel (PDSCH) transmission; wherein Resource Allocation Type 0 is configured for the UE; wherein the one or more second fields that are repurposed to indicate the one or more Type 3 HARQ codebooks include: a virtual resource block to physical resource block (VRB-to-PRB) mapping field included in the downlink communication, and a carrier indicator field (CIF) included in the downlink communication.

Aspect 29: The method of Aspect 28, wherein cross carrier scheduling is activated for the UE; wherein a first bit of the CIF is set to a 1-value; and wherein the one or more Type 3 HARQ codebooks are indicated by a combination of a plurality of second bits included in the CIF and a first bit included in the VRB-to-PRB mapping field.

Aspect 30: The method of one or more of Aspects 20-29, wherein the downlink communication schedules a physical downlink shared channel (PDSCH) transmission; wherein Resource Allocation Type 0 is configured for the UE; wherein cross carrier scheduling is configured for the UE; wherein a carrier indicator field (CIF), included in the downlink communication, includes a first bit set to a 0-value; wherein the UE does not support active bandwidth part (BWP) switching via downlink control information (DCI); and wherein the one or more second fields that are repurposed to indicate the one or more Type 3 HARQ codebooks include: a BWP indicator field (BWPIF) included in the downlink communication, and a virtual resource block to physical resource block (VRB-to-PRB) mapping field included in the downlink communication.

Aspect 31: The method of one or more of Aspects 20-30, wherein the downlink communication schedules a physical downlink shared channel (PDSCH) transmission; wherein Resource Allocation Type 0 is configured for the UE; wherein cross carrier scheduling is configured for the UE; wherein a carrier indicator field (CIF), included in the downlink communication, includes a first bit set to a 0-value; wherein the UE does not support active bandwidth part (BWP) switching via downlink control information (DCI); wherein physical resource block (PRB) bundling is not configured for the UE; and wherein the one or more second fields that are repurposed to indicate the one or more Type 3 HARQ codebooks include: a BWP indicator field (BWPIF) included in the downlink communication, and a PRB bundling size indicator (PRBBSI) field included in the downlink communication.

Aspect 32: The method of one or more of Aspects 20-31, wherein the downlink communication schedules a physical downlink shared channel (PDSCH) transmission; wherein the UE is configured with zero (0) aperiodic zero power channel state information reference signal (ZP CSI-RS) resource sets; and wherein the one or more second fields that are repurposed to indicate the one or more Type 3 HARQ codebooks include a ZP CSI-RS trigger field included in the downlink communication.

Aspect 33: The method of Aspect 32, wherein the one or more second fields that are repurposed to indicate the one or more Type 3 HARQ codebooks include at least one of: a virtual resource block to physical resource block (VRB-to-PRB) mapping field included in the downlink communication, a PRB bundling size indicator (PRBBSI) field included in the downlink communication, or a carrier indicator field (CIF) included in the downlink communication.

Aspect 34: The method of one or more of Aspects 20-33, wherein a maximum number of codewords scheduled by downlink control information (maxNrofCodeWordsScheduledByDCI) parameter is configured as two (2) for the UE; wherein the downlink communication schedules a physical downlink shared channel (PDSCH) transmission; wherein the PDSCH transmission includes a single codeword; and wherein the one or more second fields that are repurposed to indicate the one or more Type 3 HARQ codebooks include a modulation coding scheme (MCS) field, that is configured to be used for a second codeword, included in the downlink communication.

Aspect 35: The method of Aspect 34, wherein one or more other fields included in the downlink communication are repurposed to indicate that the MCS field is repurposed to indicate the one or more Type 3 HARQ codebooks; and wherein the one or more other fields include at least one of: a virtual resource block to physical resource block (VRB-to-PRB) mapping field included in the downlink communication, a bandwidth part indicator field (BWPIF) included in the downlink communication, or a carrier indicator field (CIF) included in the downlink communication.

Aspect 36: The method of one or more of Aspects 20-35, wherein the downlink communication does not schedule a physical downlink shared channel (PDSCH) transmission; wherein the one or more second fields that are repurposed to indicate the one or more Type 3 HARQ codebooks include at least one of: a modulation coding scheme (MCS) field included in the downlink communication, a downlink assignment index (DAI) field included in the downlink communication, an HARQ process number (HPN) field included in the downlink communication, a virtual resource block to physical resource block (VRB-to-PRB) mapping field included in the downlink communication, a bandwidth part indicator field (BWPIF) included in the downlink communication, a carrier indicator field (CIF) included in the downlink communication, a PRB bundling size indicator (PRBB SI) field included in the downlink communication, or a zero power channel state information reference signal (ZP CSI-RS) trigger field included in the downlink communication.

Aspect 37: The method of Aspect 36, wherein the one or more second fields, that are repurposed to indicate the one or more Type 3 HARQ codebooks, indicate a plurality of Type 3 HARQ codebooks.

Aspect 38: The method of one or more of Aspects 20-37, further comprising: transmitting a configuration that indicates the one or more second fields that are repurposed to indicate one or more Type 3 HARQ codebooks.

Aspect 39: An apparatus for wireless communication at a device, comprising a processor; memory coupled with the processor; and instructions stored in the memory and executable by the processor to cause the apparatus to perform the method of one or more of Aspects 1-19.

Aspect 40: A device for wireless communication, comprising a memory and one or more processors coupled to the memory, the one or more processors configured to perform the method of one or more of Aspects 1-19.

Aspect 41: An apparatus for wireless communication, comprising at least one means for performing the method of one or more of Aspects 1-19.

Aspect 42: A non-transitory computer-readable medium storing code for wireless communication, the code comprising instructions executable by a processor to perform the method of one or more of Aspects 1-19.

Aspect 43: A non-transitory computer-readable medium storing a set of instructions for wireless communication, the set of instructions comprising one or more instructions that, when executed by one or more processors of a device, cause the device to perform the method of one or more of Aspects 1-19.

Aspect 44: An apparatus for wireless communication at a device, comprising a processor; memory coupled with the processor; and instructions stored in the memory and executable by the processor to cause the apparatus to perform the method of one or more of Aspects 20-38.

Aspect 45: A device for wireless communication, comprising a memory and one or more processors coupled to the memory, the one or more processors configured to perform the method of one or more of Aspects 20-38.

Aspect 46: An apparatus for wireless communication, comprising at least one means for performing the method of one or more of Aspects 20-38.

Aspect 47: A non-transitory computer-readable medium storing code for wireless communication, the code comprising instructions executable by a processor to perform the method of one or more of Aspects 20-38.

Aspect 48: A non-transitory computer-readable medium storing a set of instructions for wireless communication, the set of instructions comprising one or more instructions that, when executed by one or more processors of a device, cause the device to perform the method of one or more of Aspects 20-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
memory; and
one or more processors coupled to the memory, the memory comprising instructions executable by the one or more processors to cause the UE to:
receive a downlink communication that includes:
a first field indicating that Type 3 hybrid automatic repeat request (HARQ) is triggered, and
one or more second fields that are repurposed to indicate one or more Type 3 HARQ codebooks configured for the UE; and
transmit HARQ feedback for the one or more Type 3 HARQ codebooks.

2. The UE of claim 1, wherein each of the one or more Type 3 HARQ codebooks includes a subset of HARQ processes that are associated with a component carrier assigned to the UE.

3. The UE of claim 1, wherein the one or more Type 3 HARQ codebooks are a subset of a plurality of Type 3 HARQ codebooks configured for the UE.

4. The UE of claim 1, wherein the downlink communication schedules a physical downlink shared channel (PDSCH) transmission;
wherein cross carrier scheduling is not activated for the UE; and
wherein the one or more second fields that are repurposed to indicate the one or more Type 3 HARQ codebooks include a carrier indicator field (CIF) included in the downlink communication.

5. The UE of claim 1, wherein the downlink communication schedules a physical downlink shared channel (PDSCH) transmission;
wherein cross carrier scheduling is activated for the UE;
wherein the one or more second fields that are repurposed to indicate the one or more Type 3 HARQ codebooks include a carrier indicator field (CIF) included in the downlink communication;
wherein a first bit of the CIF is set to a 1-value; and
wherein a plurality of second bits of the CIF are repurposed to indicate the one or more Type 3 HARQ codebooks.

6. The UE of claim 5, wherein the plurality of second bits indicate the one or more Type 3 HARQ codebooks based at least in part on the one or more Type 3 HARQ codebooks being default Type 3 HARQ codebooks for the UE.

7. The UE of claim 1, wherein the downlink communication schedules a physical downlink shared channel (PDSCH) transmission;
wherein the UE does not support active bandwidth part (BWP) switching via downlink control information (DCI); and
wherein the one or more second fields that are repurposed to indicate the one or more Type 3 HARQ codebooks include a BWP indicator field (BWPIF) included in the downlink communication.

8. The UE of claim 7, wherein the one or more Type 3 HARQ codebooks are associated with lowest Type 3 HARQ codebook identifiers for the UE, or
wherein the one or more Type 3 HARQ codebooks are default Type 3 HARQ codebooks for the UE.

9. The UE of claim 1, wherein the downlink communication does not schedule a physical downlink shared channel (PDSCH) transmission;
wherein the one or more second fields that are repurposed to indicate the one or more Type 3 HARQ codebooks include at least one of:
a modulation coding scheme (MCS) field included in the downlink communication,
a downlink assignment index (DAI) field included in the downlink communication,
an HARQ process number (HPN) field included in the downlink communication,
a virtual resource block to physical resource block (VRB-to-PRB) mapping field included in the downlink communication,
a bandwidth part indicator field (BWPIF) included in the downlink communication,
a carrier indicator field (CIF) included in the downlink communication,
a PRB bundling size indicator (PRBBSI) field included in the downlink communication, or
a zero power channel state information reference signal (ZP CSI-RS) trigger field included in the downlink communication.

10. The UE of claim 9, wherein the one or more second fields, that are repurposed to indicate the one or more Type 3 HARQ codebooks, indicate a plurality of Type 3 HARQ codebooks.

11. A base station for wireless communication, comprising:
memory; and
one or more processors coupled to the memory, the memory comprising instructions executable by the one or more processors to cause the base station to:
transmit a downlink communication that includes:
a first field indicating that Type 3 hybrid automatic repeat request (HARQ) is triggered, and
one or more second fields that are repurposed to indicate one or more Type 3 HARQ codebooks configured for a user equipment (UE);
and
receive, from the UE, HARQ feedback for the one or more Type 3 HARQ codebooks.

12. The base station of claim 11, wherein the downlink communication schedules a physical downlink shared channel (PDSCH) transmission;
wherein Resource Allocation Type 0 is configured for the UE;
wherein the one or more second fields that are repurposed to indicate the one or more Type 3 HARQ codebooks include:
a virtual resource block to physical resource block (VRB-to-PRB) mapping field included in the downlink communication, and
a carrier indicator field (CIF) included in the downlink communication.

13. The base station of claim 12, wherein cross carrier scheduling is activated for the UE;
wherein a first bit of the CIF is set to a 1-value; and
wherein the one or more Type 3 HARQ codebooks are indicated by a combination of a plurality of second bits included in the CIF and a first bit included in the VRB-to-PRB mapping field.

14. The base station of claim 11, wherein the downlink communication schedules a physical downlink shared channel (PDSCH) transmission;
wherein Resource Allocation Type 0 is configured for the UE;
wherein cross carrier scheduling is configured for the UE;
wherein a carrier indicator field (CIF), included in the downlink communication, includes a first bit set to a 0-value;
wherein the UE does not support active bandwidth part (BWP) switching via downlink control information (DCI); and
wherein the one or more second fields that are repurposed to indicate the one or more Type 3 HARQ codebooks include:
a BWP indicator field (BWPIF) included in the downlink communication, and
a virtual resource block to physical resource block (VRB-to-PRB) mapping field included in the downlink communication.

15. The base station of claim 14, wherein the downlink communication schedules a physical downlink shared channel (PDSCH) transmission;
wherein Resource Allocation Type 0 is configured for the UE;
wherein cross carrier scheduling is configured for the UE;
wherein a carrier indicator field (CIF), included in the downlink communication, includes a first bit set to a 0-value;
wherein the UE does not support active bandwidth part (BWP) switching via downlink control information (DCI);
wherein physical resource block (PRB) bundling is not configured for the UE; and
wherein the one or more second fields that are repurposed to indicate the one or more Type 3 HARQ codebooks include:
a BWP indicator field (BWPIF) included in the downlink communication, and
a PRB bundling size indicator (PRBBSI) field included in the downlink communication.

16. The base station of claim 11, wherein the downlink communication does not schedule a physical downlink shared channel (PDSCH) transmission;
wherein the one or more second fields that are repurposed to indicate the one or more Type 3 HARQ codebooks include at least one of:
a modulation coding scheme (MCS) field included in the downlink communication,
a downlink assignment index (DAI) field included in the downlink communication,
an HARQ process number (HPN) field included in the downlink communication,
a virtual resource block to physical resource block (VRB-to-PRB) mapping field included in the downlink communication,
a bandwidth part indicator field (BWPIF) included in the downlink communication,
a carrier indicator field (CIF) included in the downlink communication,
a PRB bundling size indicator (PRBBSI) field included in the downlink communication, or
a zero power channel state information reference signal (ZP CSI-RS) trigger field included in the downlink communication.

17. The base station of claim 16, wherein the one or more second fields, that are repurposed to indicate the one or more Type 3 HARQ codebooks, indicate a plurality of Type 3 HARQ codebooks.

18. The base station of claim 11, wherein the memory further comprises instructions executable by the one or more processors to cause the base station to:
transmit a configuration that indicates the one or more second fields that are repurposed to indicate one or more Type 3 HARQ codebooks.

19. A method of wireless communication performed by a user equipment (UE), comprising:
receiving a downlink communication that includes:
a first field indicating that Type 3 hybrid automatic repeat request (HARQ) is triggered, and
one or more second fields that are repurposed to indicate one or more Type 3 HARQ codebooks configured for the UE; and
transmitting HARQ feedback for the one or more Type 3 HARQ codebooks.

20. The method of claim 19, wherein a maximum number of codewords scheduled by downlink control information (maxNrofCodeWordsScheduledByDCl) parameter is configured as two (2) for the UE;
wherein the downlink communication schedules a physical downlink shared channel (PDSCH) transmission;
wherein the PDSCH transmission includes a single codeword; and
wherein the one or more second fields that are repurposed to indicate the one or more Type 3 HARQ codebooks include a modulation coding scheme (MCS) field, that is configured to be used for a second codeword, included in the downlink communication.

21. The method of claim 20, wherein one or more other fields included in the downlink communication are repurposed to indicate that the MCS field is repurposed to indicate the one or more Type 3 HARQ codebooks; and
wherein the one or more other fields include at least one of:
a virtual resource block to physical resource block (VRB-to-PRB) mapping field included in the downlink communication,
a bandwidth part indicator field (BWPIF) included in the downlink communication, or
a carrier indicator field (CIF) included in the downlink communication.

22. The method of claim 19, wherein the downlink communication does not schedule a physical downlink shared channel (PDSCH) transmission;
wherein the one or more second fields that are repurposed to indicate the one or more Type 3 HARQ codebooks include at least one of:
a modulation coding scheme (MCS) field included in the downlink communication,
a downlink assignment index (DAI) field included in the downlink communication,
an HARQ process number (HPN) field included in the downlink communication,
a virtual resource block to physical resource block (VRB-to-PRB) mapping field included in the downlink communication,
a bandwidth part indicator field (BWPIF) included in the downlink communication,
a carrier indicator field (CIF) included in the downlink communication,
a PRB bundling size indicator (PRBBSI) field included in the downlink communication, or
a zero power channel state information reference signal (ZP CSI-RS) trigger field included in the downlink communication.

23. The method of claim 22, wherein the one or more second fields, that are repurposed to indicate the one or more Type 3 HARQ codebooks, indicate a plurality of Type 3 HARQ codebooks.

24. The method of claim 19, further comprising:
receiving a configuration that indicates the one or more second fields that are repurposed to indicate one or more Type 3 HARQ codebooks.

25. A method of wireless communication performed by a base station, comprising:
transmitting a downlink communication that includes:
a first field indicating that Type 3 hybrid automatic repeat request (HARQ) is triggered, and
one or more second fields that are repurposed to indicate one or more Type 3 HARQ codebooks configured for a user equipment (UE); and
receiving, from the UE, HARQ feedback for the one or more Type 3 HARQ codebooks.

26. The method of claim 25, wherein the downlink communication schedules a physical downlink shared channel (PDSCH) transmission;
wherein the UE is configured with zero (0) aperiodic zero power channel state information reference signal (ZP CSI-RS) resource sets; and
wherein the one or more second fields that are repurposed to indicate the one or more Type 3 HARQ codebooks include a ZP CSI-RS trigger field included in the downlink communication.

27. The method of claim 26, wherein the one or more second fields that are repurposed to indicate the one or more Type 3 HARQ codebooks include at least one of:
a virtual resource block to physical resource block (VRB-to-PRB) mapping field included in the downlink communication,
a PRB bundling size indicator (PRBBSI) field included in the downlink communication, or
a carrier indicator field (CIF) included in the downlink communication.

28. The method of claim 25, wherein a maximum number of codewords scheduled by downlink control information (maxNrofCodeWordsScheduledByDCI) parameter is configured as two (2) for the UE;
wherein the downlink communication schedules a physical downlink shared channel (PDSCH) transmission;
wherein the PDSCH transmission includes a single codeword; and
wherein the one or more second fields that are repurposed to indicate the one or more Type 3 HARQ codebooks include a modulation coding scheme (MCS) field, that is configured to be used for a second codeword, included in the downlink communication.

29. The method of claim 25, wherein the downlink communication does not schedule a physical downlink shared channel (PDSCH) transmission;
wherein the one or more second fields that are repurposed to indicate the one or more Type 3 HARQ codebooks include at least one of:
a modulation coding scheme (MCS) field included in the downlink communication,
a downlink assignment index (DAI) field included in the downlink communication,
an HARQ process number (HPN) field included in the downlink communication,
a virtual resource block to physical resource block (VRB-to-PRB) mapping field included in the downlink communication,
a bandwidth part indicator field (BWPIF) included in the downlink communication,
a carrier indicator field (CIF) included in the downlink communication,
a PRB bundling size indicator (PRBBSI) field included in the downlink communication, or
a zero power channel state information reference signal (ZP CSI-RS) trigger field included in the downlink communication.

30. The method of claim 29, wherein the one or more second fields, that are repurposed to indicate the one or more Type 3 HARQ codebooks, indicate a plurality of Type 3 HARQ codebooks.
